(19) United States
(12) Patent Application Publication
(10) Pub. No.: US 2014/0058903 A1
(43) Pub. Date: Feb. 27, 2014

(54) APPARATUS AND METHODS FOR DISPLAYING PROJECT PORTFOLIOS AND SELLING PRODUCTS FROM THE PROJECT PORTFOLIOS

(71) Applicants: Zelos H. Hong, Pasadena, CA (US); Vu Tran, Reseda, CA (US)

(72) Inventors: Zelos H. Hong, Pasadena, CA (US); Vu Tran, Reseda, CA (US)

(21) Appl. No.: 14/068,939

(22) Filed: Oct. 31, 2013

Related U.S. Application Data
(63) Continuation of application No. 13/546,544, filed on Jul. 11, 2012.

(51) Int. Cl. G06Q 30/06

(52) U.S. Cl. CPC G06Q 30/0641
USPC 705/27.1

(57) ABSTRACT

A machine-readable medium comprising a set of programmed instructions, the set of programmed instructions when executed by a system configured to cause the system to perform a method for displaying and transacting business off a project portfolio, the method comprising: providing a products database, the products database comprising a plurality of products; creating a digital mood board from a user selection of a plurality of products from the products database; storing the digital mood board into a project portfolio; displaying the project portfolio; and accepting a sales transaction for a product from the project portfolio.

### CROSS REFERENCE TO RELATED APPLICATION

This application is a continuation of U.S. patent application Ser. No. 13/546,544 filed Jul. 11, 2012 which is incorporated herein by reference for all purposes.

### FIELD OF THE INVENTION

This application relates to apparatus and methods for facilitating electronic shopping and electronic transactions, and in particular, apparatus and methods for displaying project portfolios that may comprise of various digital mood boards and facilitating electronic shopping and electronic transactions from the project portfolios, including the digital mood boards.

### BACKGROUND

Professionals, such as interior designers, architects, and photographers, may use project portfolios of their work to market and sell their services. Their project portfolios may be a physical binder or album. Their project portfolios may be composed of various projects they may have compiled or completed. Each project portfolio may display various commercially available products used to complete the project. For instance, an interior designer's project may include various furnitures, appliances, draperies, and accessories. Another way professionals create project portfolios is by storing a set of digital photos of their work in a computer that they can show to their customers. The advent of digital photos and on-line digital photo storage has also made it feasible for websites to display portfolios of past work by professionals.

Despite these advances in technology, consumers may still have to search through various websites to find the retailers that sell the items displayed on the portfolios. None of these conventional portfolios have the ability to allow viewers to instantly buy the items displayed on the professional's portfolios. A single centralized site where one can create, view professional portfolios, and instantly purchase the items displayed on the portfolios is desired.

From the professionals' perspective, the conventional portfolios do not provide them the convenience they desire when shopping for products they want to use in their projects. They still have to search through various catalogs to find the products, or they may have to contact various vendors to obtain a quote, place an order, and keep track of the status of the order. The professionals may also have to save, carry, and view multiple catalogs, such as a catalog for furnitures, another catalog for appliances, and another catalog for fabric. Furthermore, the professionals may lack a tool to help them visualize their projects by placing various products together by collating images of products and manipulating and editing said images to visualize a completed environment. There is a long felt need for systems and methods that can make the process of creating a professional portfolio and purchasing products from a professional's portfolio easier and more efficient than the aforementioned prior art methods.

### SUMMARY

The present invention includes a machine-readable medium comprising a set of programmed instructions, the set of programmed instructions, when executed by a system, is configured to cause the system to perform a method for displaying and transacting business off a project portfolio, the method comprising: providing a products database, the products database comprising a plurality of products; creating a project portfolio from a user selection of a plurality of products from the products database; storing the project portfolio; displaying the project portfolio; and accepting a sales transaction for a product from the project portfolio.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims.

### BRIEF DESCRIPTION OF THE DRAWINGS

FIG. 1 is substantially a network diagram of an exemplary system of the present invention.

FIG. 2 is substantially a more detailed network diagram of the exemplary system of FIG. 1.

FIG. 3 is substantially a flowchart showing the steps that may be executed by an embodiment of a portfolio application of the present invention.

FIG. 4 is substantially a flowchart showing the steps that may be executed by an embodiment of a sales application of the present invention.

FIG. 5 is substantially a flowchart showing the steps that may be executed by another embodiment of a sales application of the present invention.

FIG. 6 is substantially a front view of an exemplary home page of the present invention.

FIG. 7 is substantially a front view of an exemplary product page of the present invention.

FIG. 8 is substantially a front view of an exemplary portfolio page of the present invention.

FIGS. 9a-9d are substantially front views of user tools which may be provided by an exemplary portfolio page of the present invention.

FIG. 10 is substantially a front view of an exemplary project page of the present invention.

FIG. 11 is substantially a flow diagram showing the communication between the client computer and the server.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. Also, it is to be understood that the phraseology and terminology employed herein are for the purpose of description and should not be regarded as limiting.

As used herein, the term “computer” may be used interchangeably with the term “server” and may be used to refer to devices that compute or perform high-speed mathematical or logical operations or that assemble, store, correlate, or otherwise process information. Each of the client computers and server may include a single or multiple processors known in the art, various memories known in the art, output devices known in the art, which may include a display unit, a printer, a speaker system, or their combinations, and input devices known in the art, which may include a mouse, keyboard, microphone, a touch screen, or their combinations. The client computers and the server may be of various forms, such as laptops, netbook computers, desktop computers, computers in smartphones, computers in tablets, computers in game consoles, and computers in mobile devices.

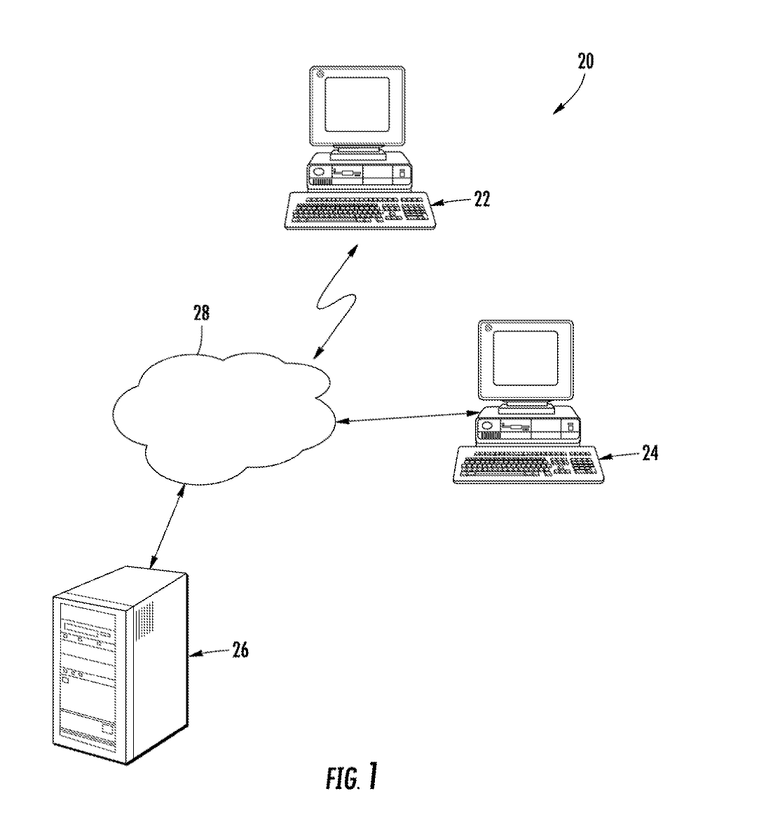

The present invention includes various embodiments of systems and methods for displaying portfolios of projects and facilitating business transactions, such as sales of products, from the display of project portfolios. Referring now to FIG. 1, a network diagram of an exemplary e-commerce system 20 is shown wherein a plurality of client computers 22 and 24 are in communication with one or more servers 26 via a network 28. The network 28 may be Local Area Networks (LANs), Wide Area Networks (WANs), wireless networks, the internet, or any other network known in the art. The network may be accessed wirelessly, through electrical cables, fiber optic cables, or other ways known in the art. Client computer 22 may be used by a seller to create and display one or more portfolios of projects. The project portfolio may include various projects that the seller physically completed for an actual client, or projects the seller may have just planned or conceptualized. Each project may be made up of one or more digital mood boards. A digital mood board may be a digital collage that may include images or text selected by one or more creators. Each digital mood board may include a plurality of products selected by the seller from a products database that may be stored in the server 26. The client computer 24 may be used by a customer to view one or more portfolios of projects, shop from the plurality of products shown within a digital mood board, and purchase the selected products.

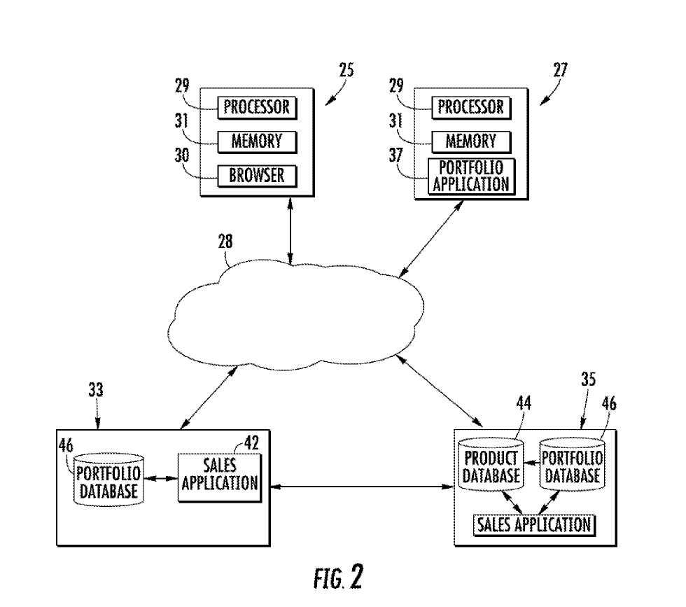

Referring now to FIG. 2, the client computer 25 may have a processor 29, a memory 31, and a browser stored in the memory 30. The first client computer 25 may access the network 28 to allow a user, such as a customer, to access a server embodiment 33 that includes a portfolio database 46 and a sales application 42. The portfolio database 46 preferably stores various project portfolios that may comprise of various projects and various digital mood boards of various sellers. The user may also shop for products that sellers have included in their project portfolios. Once the user is ready to make a purchase, the server may provide the user access to a sales application 42 to facilitate and complete the purchase transaction.

The exemplary system may also include a second client computer 27, which may have a processor 29, a memory 31, and a portfolio application 37 stored in the memory 31. The second client computer 27 may allow a user, such as a seller, to use the portfolio application 37 to create and store project portfolios, projects, and digital mood boards by uploading product images and product information. It can be appreciated that the second client computer 27 may be a standalone system and may allow users to create their portfolios without relying on a network. The second client computer 27 may be flexible and may connect through the network 28 to another server embodiment 35 that includes a product database 44 that stores various product photos and information, which the seller can use to increase the content of the seller's project portfolios. The server embodiment 35 may also have its own portfolio database 48 to allow users to browse project portfolios of others and a sales application 42 to facilitate and process transactions. Alternatively, server embodiment 35 may be in communication with server 33 to share resources, such as the databases and applications. The portfolio application 37 may also be stored in one of the servers 33 or 35 so that it can be available to the users.

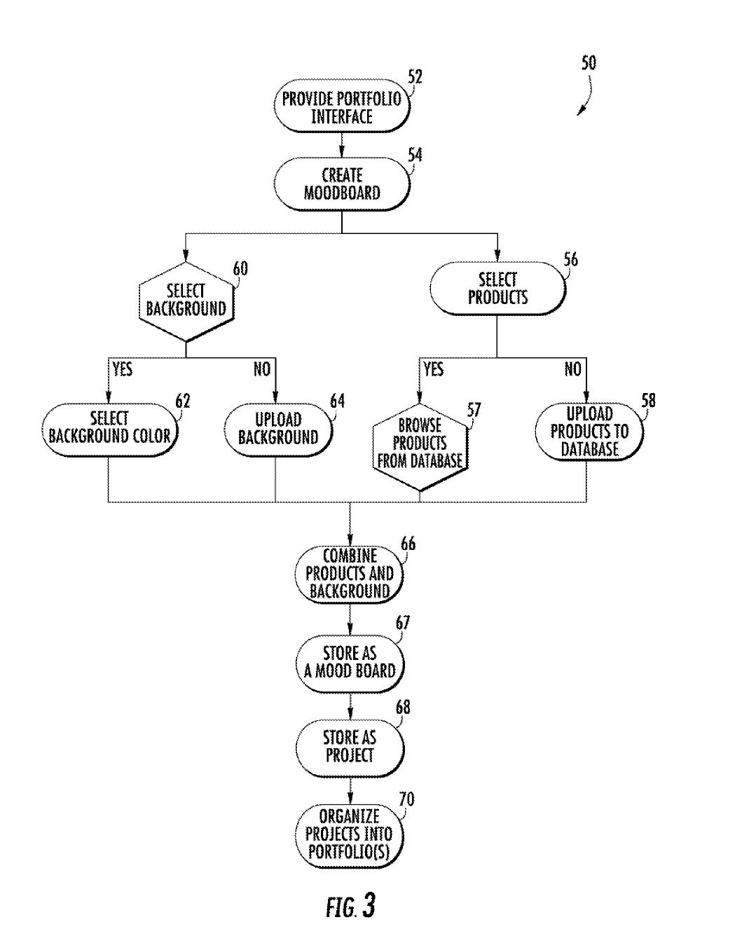

Referring now to FIG. 3, the portfolio application 37 may execute the steps shown in flowchart 50 wherein at step 52, a portfolio interface, such as the web pages discussed below, may be provided. The portfolio application may prompt the user to create a digital mood board if the user has not previously saved any digital mood board or if the user desires to create a new digital mood board (step 54). The application may prompt the user to select products to include in the user's digital mood board (step 56). If the user chooses to select products provided in the products database, the user may choose to browse products from the database (Step 57). The products in the database preferably include at least an image, a product description, and a price. The products may include a description or reviews from previous buyers. The user may then indicate the user's selection of products to include in his or her digital mood board. If the user does not want to browse products from the database, the user may be allowed to upload products into the database (step 58). The application is preferably configured such that products and associated product information uploaded by the user meet certain requirements, including a name, description, detailed information, and product images. It is noted that while the users may be able to upload their own products into the database to display in their portfolios, an administrator may have to approve the products before they can be sold. For instance, the administrator may have to set the price, find the source, review product quality, and obtain inventory of the products before they can be sold.

Next, the user may be prompted whether to select a stored environmental background from the database (step 60). The environmental background may provide context for visualizing the placement and matching of the products and enhance the product discovery experience for the user. For instance, if the products are kitchen appliances, the environmental background that may be provided may be pictures of various kitchen backdrops where the appliances may be installed. In another example, a user may select the background of the user's actual room in the user's home so that the user can visualize how a product or set of products may look after purchase and placement in the user's home. After the user is done browsing, the user may select the background color (step 62). If the user does not want to browse any stored environmental background, the user may upload his or her own environmental background (step 64). The selected or uploaded products may then be combined with the selected or uploaded environmental background (step 66) and may be stored as a digital mood board (step 67). If the user has created multiple digital mood boards, they can be stored into a project folder (step 68). In embodiments where the projects relate to interior designs, each project folder may be named as a room or location in the house shown in the mood board, such as a living room, dining room, master bedroom, and the like. When there are multiple projects created, the projects may be organized into portfolios (Step 70), and in embodiments where the projects relate to interior designs, each portfolio may be named by the client name. As an example, a user may have various portfolios, such as Client 1's Residence, Client 2's Residence, and Client 3's Residence. Client 1's Residence may include various projects, such as a living room, a dining room, a kitchen, and a master bedroom. The living room for Client 1's residence may have various digital mood boards providing a viewer with various themes for the living room, such as Contemporary, Roman, or Asian themes.

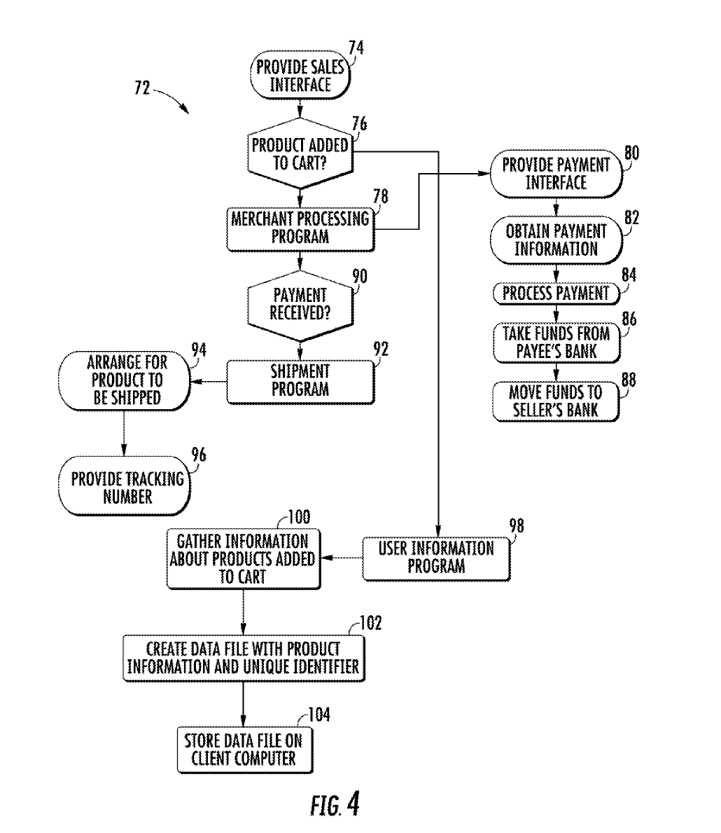

Referring now to FIG. 4, the sales application may execute the steps shown in flowchart 72 wherein at step 74, the sales application preferably provides a sales interface to a user, such as the webpages discussed below. If the user indicates to add a product to a shopping cart (step 76), the sales application preferably activates a merchant processing program (step 78). The merchant processing program may provide a payment interface (step 80), obtain payment information, such as a credit card number, debit card number, or financial institution information of the customer (step 82), process the payment (step 84), take funds from the customer's bank (step 86), and move fund to the seller's bank (step 88).

When a user indicates to add a product to a shopping cart (Step 76), the sales application may also be configured to initiate a user information program (Step 98). The user information program may be configured to gather information related to the products added to the cart by the user (Step 100). The program may then create a data file (also known as a “cookie”) containing such product information along with a unique identifier for later identification and access by the sales interface (Step 102). The program may then store the data file on the client computer (Step 104) such that when the user accesses the sales interface using the same client computer, the sales interface may access the data file and quickly identify previous product purchases by the user, or other information such as the user's certain tastes, preferences, or future predicted product needs. The user information program may further be configured to be initiated by other actions by the user, such as simply viewing a certain product in detail, or searching for a particular product or specialized query.

Next, the sales application preferably verifies that the payment from the customer has been received (step 90). Once the payment has been received, the sales application preferably activates a shipment program (step 92) wherein the product is arranged to be shipped to the customer (step 94) and tracking number is provided to the customer (step 96).

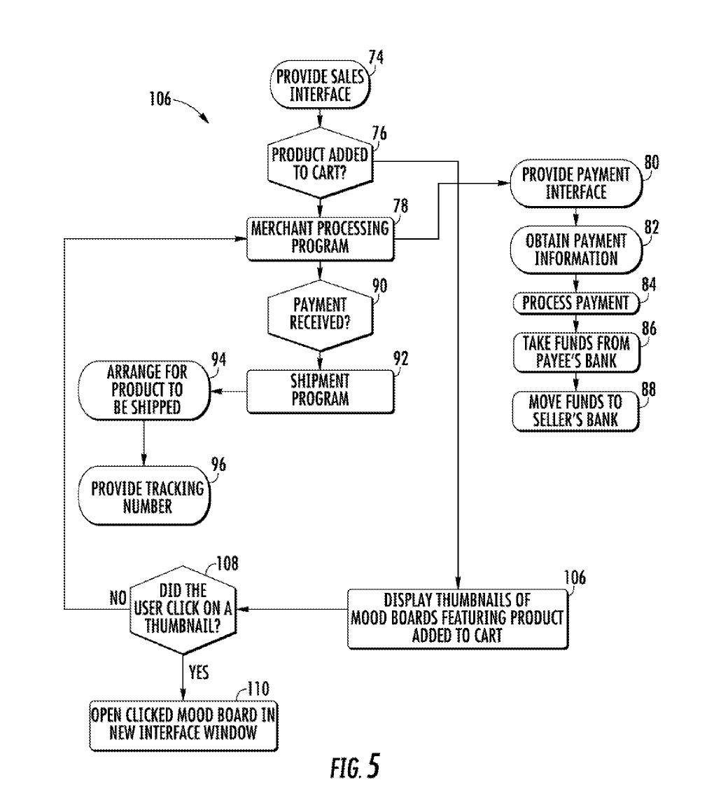

FIG. 5 displays another embodiment of the sales application which may execute the steps shown in flowchart 106. Flowchart 106 has some of the exact steps as shown in flowchart 72 of FIG. 4 and already described above. However, flowchart 106 preferably adds the following steps after the user indicates to add a product to a shopping cart (step 76). At step 106, the sales application may display to the user small images of the digital mood boards stored in the portfolio database that incorporate the product added to the cart by the user. Users may be able to select the image of a digital mood board to open a full view of the digital mood board stored in the portfolio database. This allows the user to browse digital mood boards stored in the portfolio database which incorporates the product added to the cart by the user, thereby allowing the user to discover other products which may complement said product or match said product in a visually pleasing set. This approach may maximize exposure of various products to the user, and increase the user's total time spent viewing the sales interface, thereby increasing the likelihood of products being purchased. The system may determine if the user has clicked on a thumbnail (step 108). Preferably, when a user selects a thumbnail of a digital mood board, the digital mood board is displayed in a new sales interface window on the client computer (step 110) such that the user is able to proceed with the merchant processing program as discussed above without disruption on the original sales interface window.

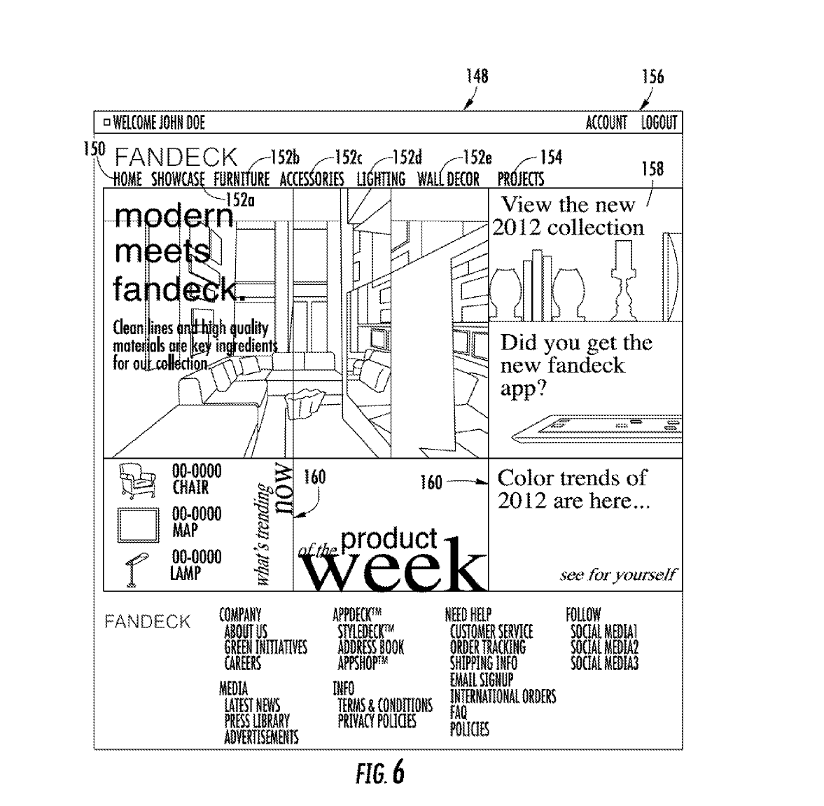

Referring now to FIG. 6, the present invention includes an exemplary e-commerce website 148. The e-commerce site embodiment 148 preferably includes a home page 150, various product and promotional pages 152a-e, and a projects page 154. A user may first create an account and log-in by clicking on the log-in area links 156. Customers may directly search and shop for products through product and promotional pages 152a-e or a catalog 158. Alternatively, customers may look at the project portfolios of various sellers through the projects page 154. Sellers may start building their projects or digital mood boards by selecting products through product and promotional pages 152a-e or a catalog 158. The e-commerce website may display certain products of interest or certain projects of interest depending on new trends, popular items, or popular projects. The e-commerce website may use a user's cookie information or other general information such as trending or popular products or projects, to display those products or projects or related products or projects in prominent areas 160 of the e-commerce website 148. In another embodiment, the e-commerce website may recognize information of the user's previous purchases, preferences, searches, and tastes stored on the user's client computer by the sales application in the form of “cookies”. These cookies may store data regarding the products the user has purchased or viewed in the past, in addition to products or projects that the user has saved, added to their shopping cart, or otherwise shown particular interest, such as by searching, viewing, purchasing, or sharing via email or social networking websites. The e-commerce website may use a user's interests or prior purchases stored in a cookie file to display in prominent areas 160 of the e-commerce website 148, certain products or projects in which the user may have a particular interest, or products or projects which are predetermined to match or be associated with the products already purchased or viewed by user.

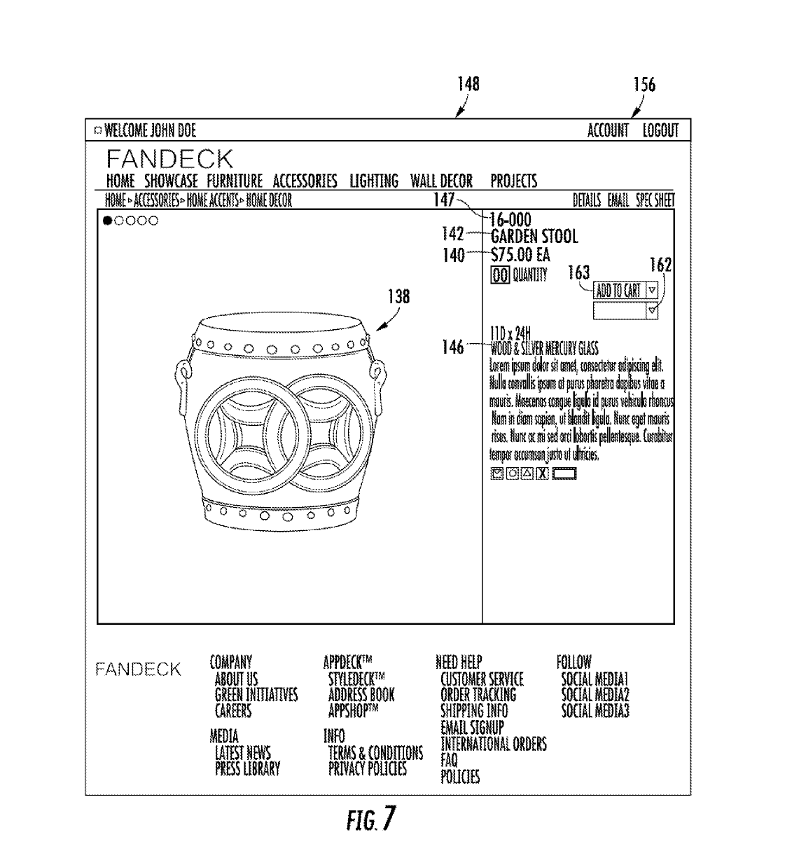

Referring now to FIG. 7, sellers may shop and find the products they want to include in their projects. Once sellers find a product they want, they can go to the page for the desired product and click on a “add to project” icon 60. In some embodiments, each of the products stored in the database preferably includes an image 138, price 140, a name 142, a description 146, and an item number 147. The associated projects of the sellers will preferably be shown from the drop down menu 62. The portfolio application 37 is preferably configured to save the selected product to the project specified from the drop down menu 62. In other embodiments (not shown), where there are a plurality of varieties of the same product, a general overview page of the product may be provided, which may include thumbnails of the various varieties. Each thumbnail of the varieties may include an item number, an image, a price, and a name.

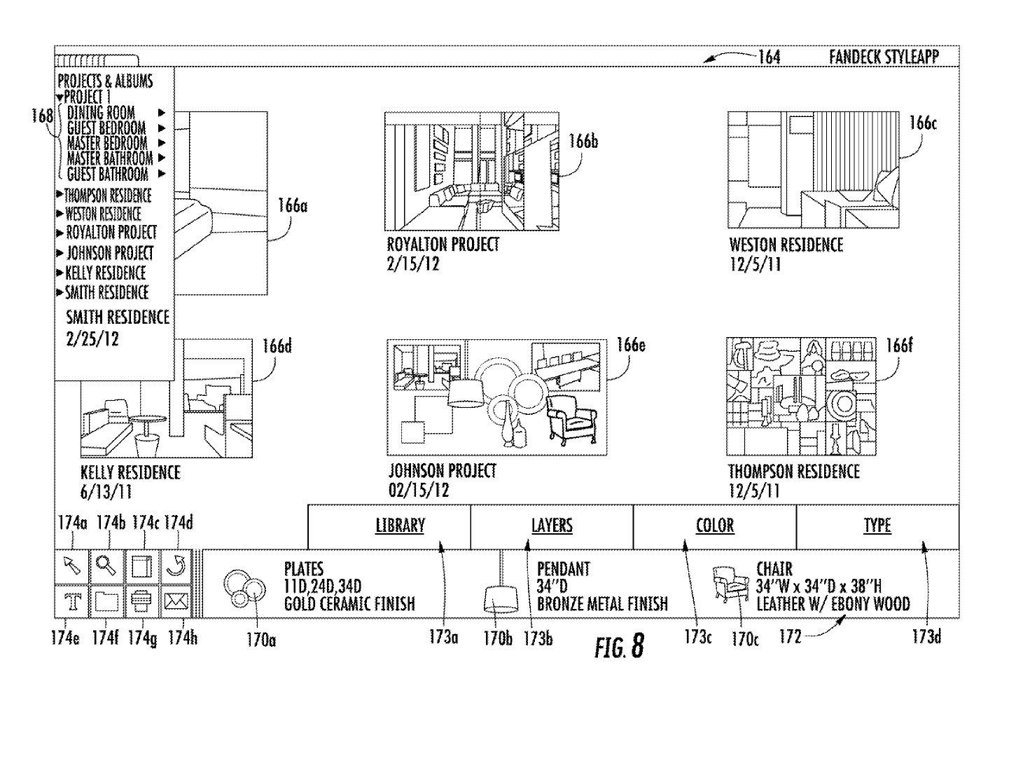

Referring now to FIG. 8, an exemplary portfolio page 164 is shown wherein a plurality of portfolios 166a-f are shown. The plurality of portfolios may be named after a client's name, such as “Johnson Project,” “Kelly Residence,” or “Thomson Residence.” The plurality of portfolios may include portfolios created in the past, present, and future. Each portfolio preferably includes their respective projects 168, which in this example, can be the different rooms in the residences, such as the dining room, the game room, the master's bedroom, and the like.

For the user to create and edit the digital mood boards in each portfolio, the portfolio page 164 may include interface tools 174a-174h provided for the user to position, modify, alter, or otherwise assemble products within certain views of a digital mood board. The interface tools may include: a tool for selecting products and positioning them within a digital mood board 174a, a tool for magnifying the view of the digital mood board 174b, a tool for scaling and adjusting the relative size of a product within a digital mood board 174c, a tool for rotating the angle and positioning of a product 174d, a tool for creating type on or around a product within a digital mood board 174e, a tool for saving a digital mood board in its current state 174f, a tool for printing a digital mood board in its current state 174g, and a tool for emailing a representation of a digital mood board in its current state 174h.

Some of the featured products 170a-170c may be displayed on a portion 172 of the portfolio page 164. The portfolio page may further include various tabs 173a-173d to provide the user with additional tools to place and manipulate the various products placed on the portfolio page 164. These tabs may include a Library tab 173a to view the various products added to the digital mood board by the user, a Layers tab 173b to manipulate the relative viewable positioning of the products or to delete any of the products placed in the digital mood board, a Color tab 173c to alter the background color or color of objects such as text, and a Type tab 173d to create and edit the appearance of text placed as an overlay onto the digital mood board by the user.

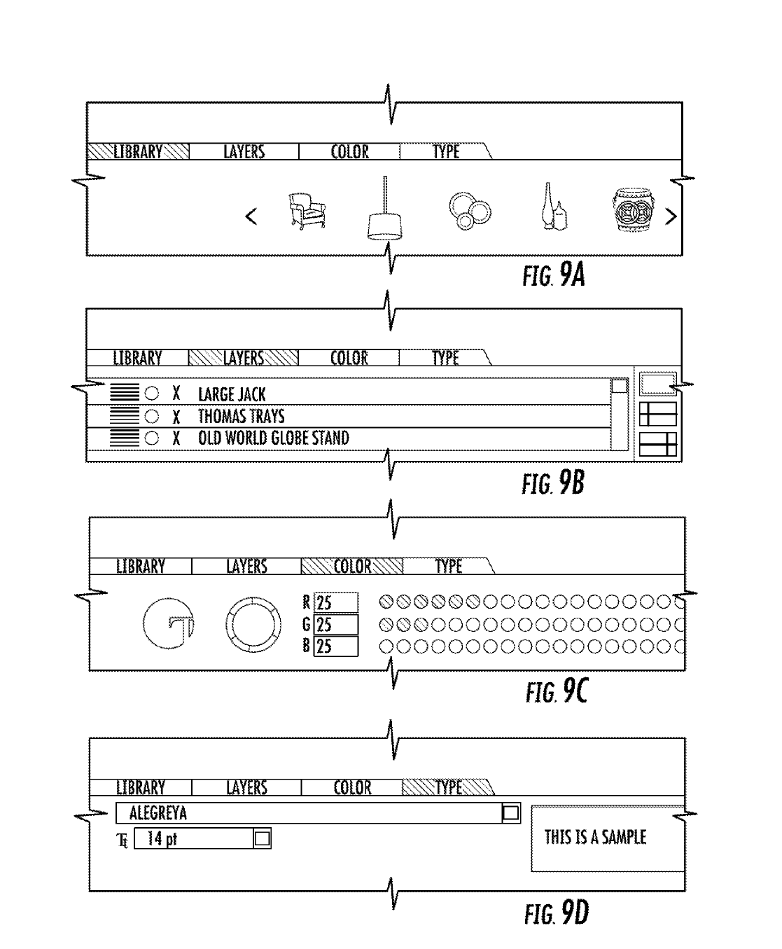

Referring now to FIGS. 9a-9d, various embodiments of the tools provided in the tabs discussed in FIG. 8 are shown. FIG. 9a shows an embodiment of the Library tab. The tools provided in the Library tab may allow the user to browse through a selection of products which the user has previously indicated to add to a digital mood board while viewing the product through the sales application. In this tab, the user may be able to select a product and drag the product onto the digital mood board space to place the product in the desired position. FIG. 9b shows an embodiment of the Layer tab which allows the user to alter and manipulate the relative positioning of the various products contained in the current digital mood board. For example in FIG. 9b, the product named “Large Jack” is placed above the products named “Thomas Trays” and “Old World Globe Stand.” This list represents the relative positioning relative to the view of the user, therefore all aspects of the “Large Jack” product would appear in front of, or on top of, all aspects of the products below it on the Layers tab, including the “Thomas Trays” and “Old World Globe Stand.” This list may be edited by the user by selecting a product and moving the product up or down the list. If a user wanted to design the project such that the “Old World Globe Stand” appeared to be in front of, or on top of, the other products, the user could select the “Old World Globe Stand” and move the product to the top of the list, thereby replacing “Large Jack” as the top-most, or front-most, displayed product in the digital mood board.

FIG. 9c shows an embodiment of the Color tab, wherein the user is able to edit the color of the background of the digital mood board, and edit the color of the text placed as an overlay on the project. The Color tab may include a color palette for the user to select a desired color, and the Color tab may further include numerical input fields to allow the user to input numerical Red-Blue-Green (“RGB”) values to create a desired color. FIG. 9d shows an embodiment of the Type tab, wherein the user is able to create text objects to place as overlays in the user's digital mood board. The user may place text overlays to save notes for future use, or to provide comments, descriptions, or suggestions to the customer viewing the digital mood board.

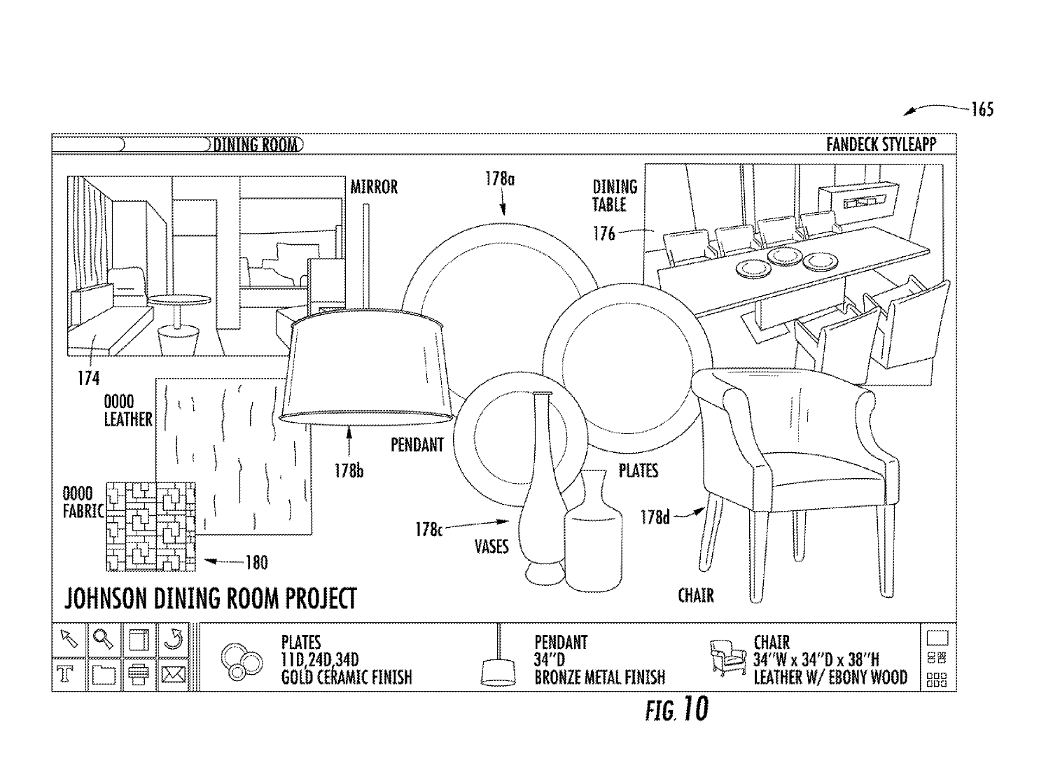

Referring now to FIG. 10, a user may select a portfolio, a project, and a mood board to view. In the example shown in FIG. 10, the user selected the Johnson Project as the portfolio and the dining room as the project. There is only one mood board offered for the dining room in this example. Various views 174 and 176 of the dining room are preferably displayed along with the products used as decorations 178a-d. 174 and 176 may also be referred to as the environmental background, as they provide an environmental setting for the products. Information about the fabric 180 used by the products, as well as any other desired information about the product, may be displayed as well. It can be appreciated that by showing the products in a project setting, users may be provided with a demonstration and the appearance of the products when incorporated into a set of other matching or associated products, which can be an effective sales approach. This sales approach may also lead to users purchasing more than one product at a time as it presents the user with suggestions for potential matches of multiple styles, colors, and types of products. If the user wants to purchase a product seen from the project, the user can simply click on the product. The detailed product page will open, such as the product page shown in FIG. 7. The user can then click on an “add to cart” icon 63.

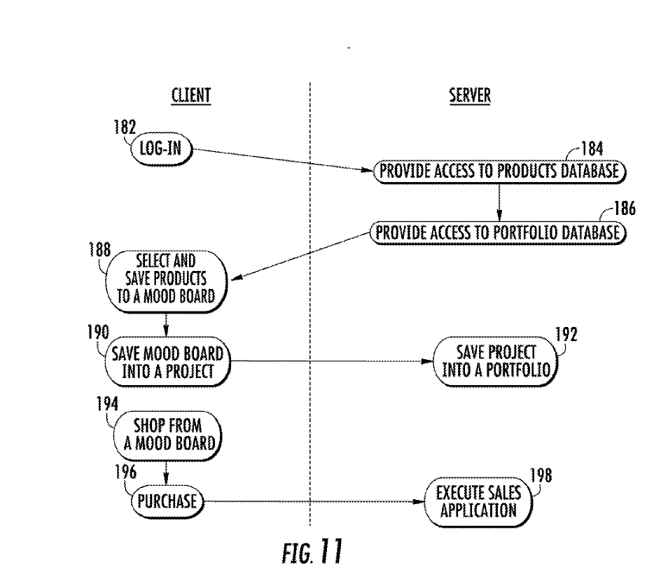

Referring now to FIG. 11, an exemplary flow diagram is provided to show the sequence of steps that may be executed between the client computers and the server. A log-in may be detected at the client computer (step 182). The portfolio application stored in the server may provide access to the products database (step 184). The server may also provide access to the portfolio database (step 186). At the client computer, the portfolio application may allow the user to select and save the desired products thereby creating a digital mood board (step 188). The digital mood board may be saved into the user's project (step 190). The user's newly created project may also be saved into a portfolio on the server (step 192) so that it may be visible to other users or to the user if accessed from a different client computer. A user or a customer may shop on the website by viewing a digital mood board and finding a product he or she is interested in purchasing (step 194). The user or the customer may indicate to purchase the product (step 196), which may be detected by the sales application program on the server. The sales application program may be executed (step 198), The sales application program may execute a series of steps to facilitate the sales transaction, such as accessing a vendor database, communicating the purchase to the vendor, accepting payment from the purchaser, confirming the sales transaction, and providing a way to track the order.

It can be realized that certain embodiments of the present invention allows sellers to group the products they have used and create a semi-custom mini catalogue or a semi-custom on-line store. Customers can instantly purchase the products they see from the sellers' portfolios, projects, or mood boards. The customers do not have to take extra steps when shopping for a product, such as looking for various products from various product catalogs or from various websites. It can further be appreciated that certain embodiments of the present invention fully maximize the use of project portfolios as marketing tools. The project portfolios may be used to demonstrate how products can be used or combined with other products for a project.

Although the description above contains many specifications, these should not be construed as limiting the scope of the invention but as merely providing illustrations of some of the presently preferred embodiments of this invention. For example, the applications disclosed could also be implemented as standalone software applications and may not necessarily be frequently connecting to a network. The client-server architecture of the invention may be varied, such as distributed or peer-to-peer architecture. The invention is capable of other embodiments and of being practiced and carried out in various ways. For instance, it is not limited to the home furnishing and interior decorating industry. The invention is further not limited in its application to the details of the construction and to the arrangement of the components set forth in the above description or as illustrated in the drawings.

We claim:

1. A system comprising:
a product database accessible via a plurality of interconnected computers, the product database comprising a plurality of products;
a portfolio application stored on at least one of said plurality of interconnected computers, the portfolio application including a portfolio interface configured to allow users to select from the plurality of products from the product database and create a digital mood board;
an output device of at least one of said plurality of interconnected computers configured to show the digital mood board comprising the selected plurality of products; and
a sales application stored on at least one of said plurality of interconnected computers and configured to allow users to enter a purchase decision to select and purchase a product from the plurality of products shown by the portfolio interface and to convert the purchase decision to an executable program to facilitate the sale of the product.

2. The system of claim 1, wherein the plurality of interconnected computers comprises a server computer, the server computer storing the product database, the portfolio application, the portfolio interface, and the sales application, the plurality of interconnected computers further comprising a client computer, the client computer being connected to the server computer via a network.

3. The system of claim 2, wherein the client computer comprises a browser, and the server computer provides the client computer with a website, the website allowing access of the portfolio interface and the sales application to the browser of the client computer.

4. The system of claim 1, wherein the executable program comprises an instruction to collect payment from the users.

5. The system of claim 4, wherein the executable program comprises an instruction to contact a vendor of a selected and purchased product and transmit at least a portion of the payment to the vendor.

6. A machine-readable medium comprising a set of programmable instructions, the set of programmable instructions, when executed by a system, configured to cause the system to perform a method for displaying and transacting business based on a project portfolio, the method comprising:
a. providing a product database, the product database comprising a plurality of products;
b. creating a digital mood board from a user selection of one or more of said plurality of products from the product database;
c. storing the digital mood board into a project portfolio;
d. displaying the project portfolio; and
e. accepting a sales transaction for a product from the project portfolio.

7. The machine-readable medium of claim 6, further comprising:
a. creating a plurality of digital mood boards;
b. storing the plurality of digital mood boards;
c. organizing the plurality of digital mood boards into a plurality of projects; and
d. organizing the plurality of projects into the project portfolio.

8. The machine-readable medium of claim 6, further comprising accepting an electronic payment from a user.

9. The machine-readable medium of claim 7, further comprising allowing the user to create a plurality of project portfolios, each of the plurality of project portfolios comprising a plurality of projects, each of the plurality of projects comprising a plurality of digital mood boards.

10. The machine-readable medium of claim 6, further comprising:
a. providing a plurality of environmental backgrounds;
b. allowing a user to select one of the plurality of environmental backgrounds; and
c. displaying the selected plurality of products with the selected environmental background.

11. The machine-readable medium of claim 6, further comprising allowing a user to upload an image of a product and including the product image in the project portfolio.

12. The machine-readable medium of claim 10, further comprising allowing a user to upload an environmental background and including the environmental background in the project portfolio.

13. A computer-implemented method for selling products, the method comprising:
a. storing in an electronic database a plurality of products, each of the products comprising a product image and a price;
b. accepting a selection input via an input device by a user a first group of products from the electronic database;
c. maintaining in a database a plurality of environmental backgrounds;
d. combining at least one of the plurality of environmental backgrounds with the selected first group of products;
e. causing to be displayed on an output device the combination of the environmental background and the first group of products; and
f. processing a payment for a sale of at least one product from the group of products.

14. The method of claim 13, further comprising storing into a first digital mood board the combination of at least one of the plurality of environmental backgrounds with the selected first group of products.

15. The method of claim 13 wherein the environmental background is a part of a residence and the plurality of products are household goods.

16. The method of claim 14, further comprising:
a. selecting a second group of products from the electronic database;
b. creating a second combination of at least one of the plurality of environmental backgrounds with the second group of products;
c. storing the second combination as a second digital mood board; and
d. organizing the first and the second combination into a product folder.

17. The method of claim 16 wherein the first digital mood board provides a first theme for a part of a residence and the second digital mood board provides a second theme for the same part of the residence.

18. The method of claim 17 further comprising naming the project folder based on the location of the part of the residence.

19. The method of claim 17 further comprising creating a plurality of project folders, each of the plurality of project folders comprising a plurality of digital mood boards, and storing the plurality of project folders into a project portfolio.

20. The method of claim 19 further comprising naming the project portfolio based on a name of a client.
